(19) United States
(12) Patent Application Publication
(10) Pub. No.: US 2024/0155338 A1
(43) Pub. Date: May 9, 2024

(54) KEY HIERARCHIES IN TRUSTED NETWORKS WITH 5G NETWORKS

(71) Applicant: QUALCOMM Incorporated, San Diego, CA (US)

(72) Inventors: Soo Bum LEE, San Diego, CA (US); Adrian Edward ESCOTT, Reading (GB); Anand PALANIGOUNDER, San Diego, CA (US)

(21) Appl. No.: 18/499,338

(22) Filed: Nov. 1, 2023

Related U.S. Application Data
(60) Provisional application No. 63/382,504, filed on Nov. 5, 2022.

(51) Int. Cl. H04W 12/041; H04W 60/04

(52) U.S. Cl. CPC H04W 12/041; H04W 60/04

(57) ABSTRACT

Various aspects of the present disclosure generally relate to wireless communication. In some aspects, a user equipment (UE) may perform a registration procedure with a mobility function of a 5G core network. Accordingly, the UE may derive a main key, associated with a trusted network gateway function, based on the registration procedure. The UE may further determine a root key based on the main key. The UE may derive a first pairwise master key (PMK), associated with a trusted network, from the root key. The UE may communicate with a first access point (AP) for the trusted network. The UE may further derive a second PMK, associated with the second AP, from the first PMK. Numerous other aspects are described.

### CROSS-REFERENCE TO RELATED APPLICATION

This Patent Application claims priority to U.S. Provisional Patent Application No. 63/382,504, filed on Nov. 5, 2022, entitled “KEY HIERARCHIES IN TRUSTED NETWORKS WITH 5G NETWORKS,” and is assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for establishing and using key hierarchies in trusted networks with 5G networks.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include a memory and one or more processors coupled to the memory. The one or more processors may be configured to perform a registration procedure with a mobility function of a 5G core network. The one or more processors may be configured to derive a main key, associated with a trusted network gateway function (TNGF), based on the registration procedure. The one or more processors may be configured to determine a root key based on the main key. The one or more processors may be configured to derive a first pairwise master key (PMK), associated with a trusted network, from the root key. The one or more processors may be configured to communicate with a first access point (AP) for the trusted network. The one or more processors may be configured to derive a second PMK, associated with a second AP, from the first PMK.

Some aspects described herein relate to an apparatus for wireless communication at a TNGF. The apparatus may include a memory and one or more processors coupled to the memory. The one or more processors may be configured to receive a main key associated with a mobility function of a 5G core network and the TNGF. The one or more processors may be configured to determine a root key based on the main key. The one or more processors may be configured to derive a first PMK, associated with a trusted network including the TNGF, from the root key. The one or more processors may be configured to derive a second PMK, associated with an AP for the trusted network, from the first PMK. The one or more processors may be configured to use the second PMK to secure communications between a UE and the AP.

Some aspects described herein relate to an apparatus for wireless communication at an AP. The apparatus may include a memory and one or more processors coupled to the memory. The one or more processors may be configured to receive a main key from a TNGF. The one or more processors may be configured to determine a root key based on the main key. The one or more processors may be configured to derive a first PMK, associated with a trusted network including the AP, from the root key. The one or more processors may be configured to receive a request to derive a second PMK for an additional AP included in the trusted network. The one or more processors may be configured to derive a second PMK, associated with the additional AP, from the first PMK. The one or more processors may be configured to transmit the second PMK to the additional AP.

Some aspects described herein relate to an apparatus for wireless communication at a TNGF. The apparatus may include a memory and one or more processors coupled to the memory. The one or more processors may be configured to receive a main key associated with a mobility function of a 5G core network and the TNGF. The one or more processors may be configured to derive a first key for an AP based on the main key. The one or more processors may be configured to derive a second key based on the main key. The one or more processors may be configured to construct a third key based on the first key and the second key. The one or more processors may be configured to transmit the third key to the AP.

Some aspects described herein relate to a method of wireless communication performed by a UE. The method may include performing a registration procedure with a mobility function of a 5G core network. The method may include deriving a main key, associated with a TNGF, based on the registration procedure. The method may include determining a root key based on the main key. The method may include deriving a first PMK, associated with a trusted network, from the root key. The method may include communicating with a first AP for the trusted network. The method may include deriving a second PMK, associated with a second AP, from the first PMK.

Some aspects described herein relate to a method of wireless communication performed by a TNGF. The method may include receiving a main key associated with a mobility function of a 5G core network and the TNGF. The method may include determining a root key based on the main key. The method may include deriving a first PMK, associated with a trusted network including the TNGF, from the root key. The method may include deriving a second PMK, associated with an AP for the trusted network, from the first PMK. The method may include using the second PMK to secure communications between a UE and the AP.

Some aspects described herein relate to a method of wireless communication performed by an AP. The method may include receiving a main key from a TNGF. The method may include determining a root key based on the main key. The method may include deriving a first PMK, associated with a trusted network including the AP, from the root key. The method may include receiving a request to derive a second PMK for an additional AP included in the trusted network. The method may include deriving a second PMK, associated with the additional AP, from the first PMK. The method may include transmitting the second PMK to the additional AP.

Some aspects described herein relate to a method of wireless communication performed by a TNGF. The method may include receiving a main key associated with a mobility function of a 5G core network and the TNGF. The method may include deriving a first key for an AP based on the main key. The method may include deriving a second key based on the main key. The method may include constructing a third key based on the first key and the second key. The method may include transmitting the third key to the AP.

Some aspects described herein relate to a non-transitory computer-readable medium that stores a set of instructions for wireless communication by a UE. The set of instructions, when executed by one or more processors of the UE, may cause the UE to perform a registration procedure with a mobility function of a 5G core network. The set of instructions, when executed by one or more processors of the UE, may cause the UE to derive a main key, associated with a TNGF, based on the registration procedure. The set of instructions, when executed by one or more processors of the UE, may cause the UE to determine a root key based on the main key. The set of instructions, when executed by one or more processors of the UE, may cause the UE to derive a first PMK, associated with a trusted network, from the root key. The set of instructions, when executed by one or more processors of the UE, may cause the UE to communicate with a first AP for the trusted network. The set of instructions, when executed by one or more processors of the UE, may cause the UE to derive a second PMK, associated with a second AP, from the first PMK.

Some aspects described herein relate to a non-transitory computer-readable medium that stores a set of instructions for wireless communication by a TNGF. The set of instructions, when executed by one or more processors of the TNGF, may cause the TNGF to receive a main key associated with a mobility function of a 5G core network and the TNGF. The set of instructions, when executed by one or more processors of the TNGF, may cause the TNGF to determine a root key based on the main key. The set of instructions, when executed by one or more processors of the TNGF, may cause the TNGF to derive a first PMK, associated with a trusted network including the TNGF, from the root key. The set of instructions, when executed by one or more processors of the TNGF, may cause the TNGF to derive a second PMK, associated with an AP for the trusted network, from the first PMK. The set of instructions, when executed by one or more processors of the TNGF, may cause the TNGF to use the second PMK to secure communications between a UE and the AP.

Some aspects described herein relate to a non-transitory computer-readable medium that stores a set of instructions for wireless communication by an AP. The set of instructions, when executed by one or more processors of the AP, may cause the AP to receive a main key from a TNGF. The set of instructions, when executed by one or more processors of the AP, may cause the AP to determine a root key based on the main key. The set of instructions, when executed by one or more processors of the AP, may cause the AP to derive a first PMK, associated with a trusted network including the AP, from the root key. The set of instructions, when executed by one or more processors of the AP, may cause the AP to receive a request to derive a second PMK for an additional AP included in the trusted network. The set of instructions, when executed by one or more processors of the AP, may cause the AP to derive a second PMK, associated with the additional AP, from the first PMK. The set of instructions, when executed by one or more processors of the AP, may cause the AP to transmit the second PMK to the additional AP.

Some aspects described herein relate to a non-transitory computer-readable medium that stores a set of instructions for wireless communication by a TNGF. The set of instructions, when executed by one or more processors of the TNGF, may cause the TNGF to receive a main key associated with a mobility function of a 5G core network and the TNGF. The set of instructions, when executed by one or more processors of the TNGF, may cause the TNGF to derive a first key for an AP based on the main key. The set of instructions, when executed by one or more processors of the TNGF, may cause the TNGF to derive a second key based on the main key. The set of instructions, when executed by one or more processors of the TNGF, may cause the TNGF to construct a third key based on the first key and the second key. The set of instructions, when executed by one or more processors of the TNGF, may cause the TNGF to transmit the third key to the AP.

Some aspects described herein relate to an apparatus for wireless communication. The apparatus may include means for performing a registration procedure with a mobility function of a 5G core network. The apparatus may include means for deriving a main key, associated with a TNGF, based on the registration procedure. The apparatus may include means for determining a root key based on the main key. The apparatus may include means for deriving a first PMK, associated with a trusted network, from the root key. The apparatus may include means for communicating with a first AP for the trusted network. The apparatus may include means for deriving a second PMK, associated with a second AP, from the first PMK.

Some aspects described herein relate to an apparatus for wireless communication. The apparatus may include means for receiving a main key associated with a mobility function of a 5G core network and the apparatus. The apparatus may include means for determining a root key based on the main key. The apparatus may include means for deriving a first PMK, associated with a trusted network including the apparatus, from the root key. The apparatus may include means for deriving a second PMK, associated with an AP for the trusted network, from the first PMK. The apparatus may include means for using the second PMK to secure communications between a UE and the AP.

Some aspects described herein relate to an apparatus for wireless communication. The apparatus may include means for receiving a main key from a TNGF. The apparatus may include means for determining a root key based on the main key. The apparatus may include means for deriving a first PMK, associated with a trusted network including the apparatus, from the root key. The apparatus may include means for receiving a request to derive a second PMK for an additional AP included in the trusted network. The apparatus may include means for deriving a second PMK, associated with the additional AP, from the first PMK. The apparatus may include means for transmitting the second PMK to the additional AP.

Some aspects described herein relate to an apparatus for wireless communication. The apparatus may include means for receiving a main key associated with a mobility function of a 5G core network and the apparatus. The apparatus may include means for deriving a first key for an AP based on the main key. The apparatus may include means for deriving a second key based on the main key. The apparatus may include means for constructing a third key based on the first key and the second key. The apparatus may include means for transmitting the third key to the AP.

Aspects generally include a method, apparatus, system, computer program product, non-transitory computer-readable medium, user equipment, base station, network entity, network node, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment in a wireless network, in accordance with the present disclosure.

FIG. 3 is a diagram illustrating another example of a wireless network, in accordance with the present disclosure.

FIGS. 4A, 4B, and 4C are diagrams illustrating examples associated with key hierarchies for a trusted network with a 5G network, in accordance with the present disclosure.

FIGS. 5A and 5B are diagrams illustrating an example associated with mobility in a trusted network used to access a 5G network, in accordance with the present disclosure.

FIGS. 6, 7, 8, and 9 are diagrams illustrating example processes associated with establishing and using key hierarchies for a trusted network with a 5G network, in accordance with the present disclosure.

FIGS. 10, 11, and 12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

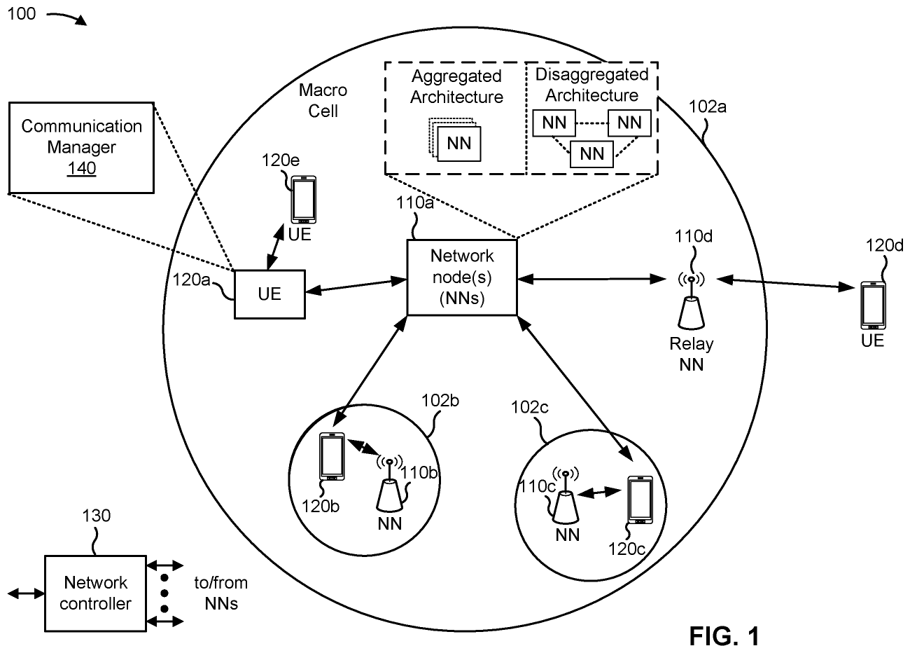

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may perform a registration procedure with a mobility function of a 5G core network; derive a main key, associated with a trusted network gateway function (TNGF), based on the registration procedure; determine a root key based on the main key; derive a first pairwise master key (PMK), associated with a trusted network, from the root key; determine to access a first access point (AP) for the trusted network; and derive a second PMK, associated with a second AP, from the first PMK. Additionally, or alternatively, the communication manager 140 may perform one or more other operations described herein.

As indicated above, FIG. 1 is provided as an example. Other examples may differ from what is described with regard to FIG. 1.

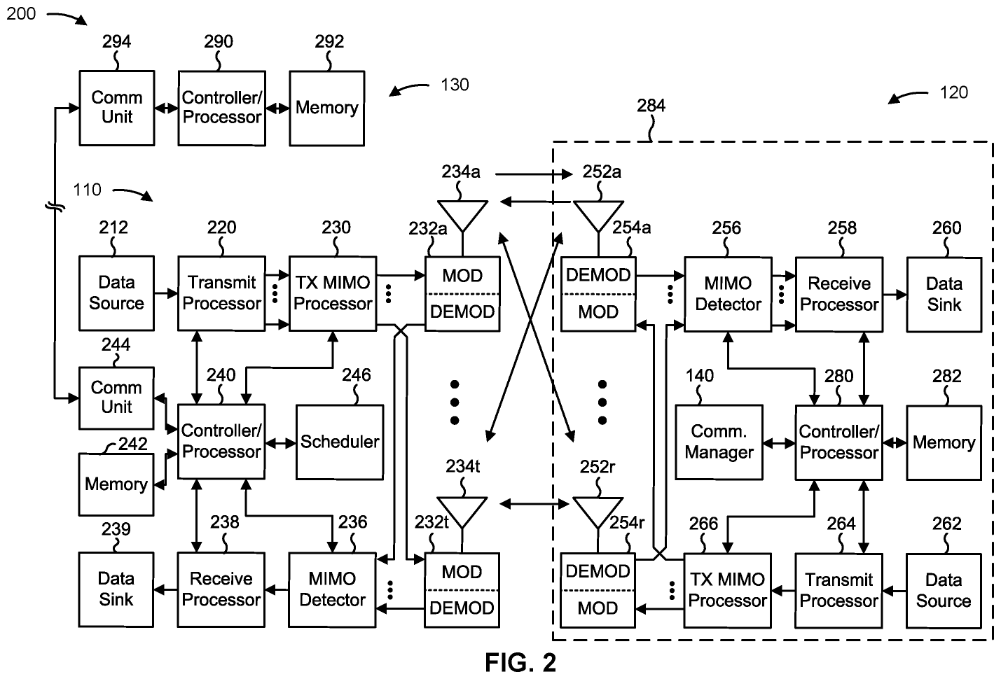

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

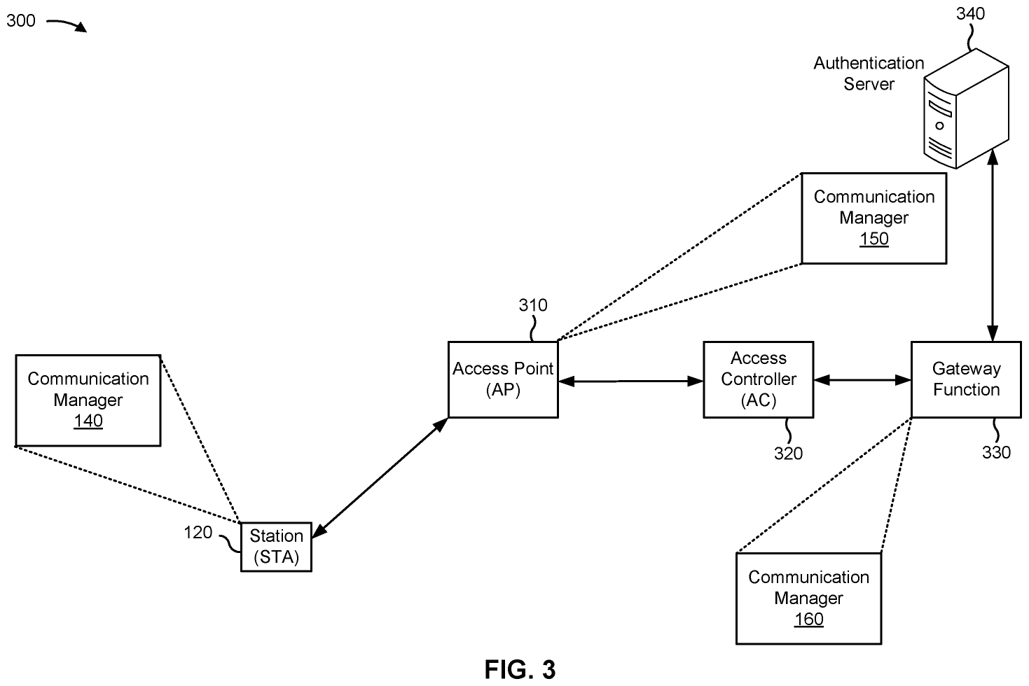

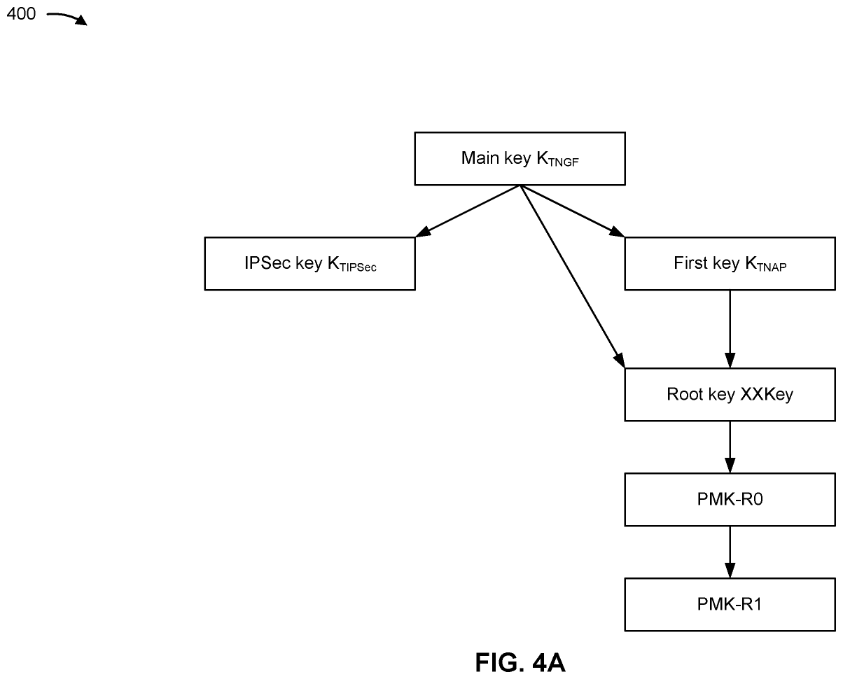

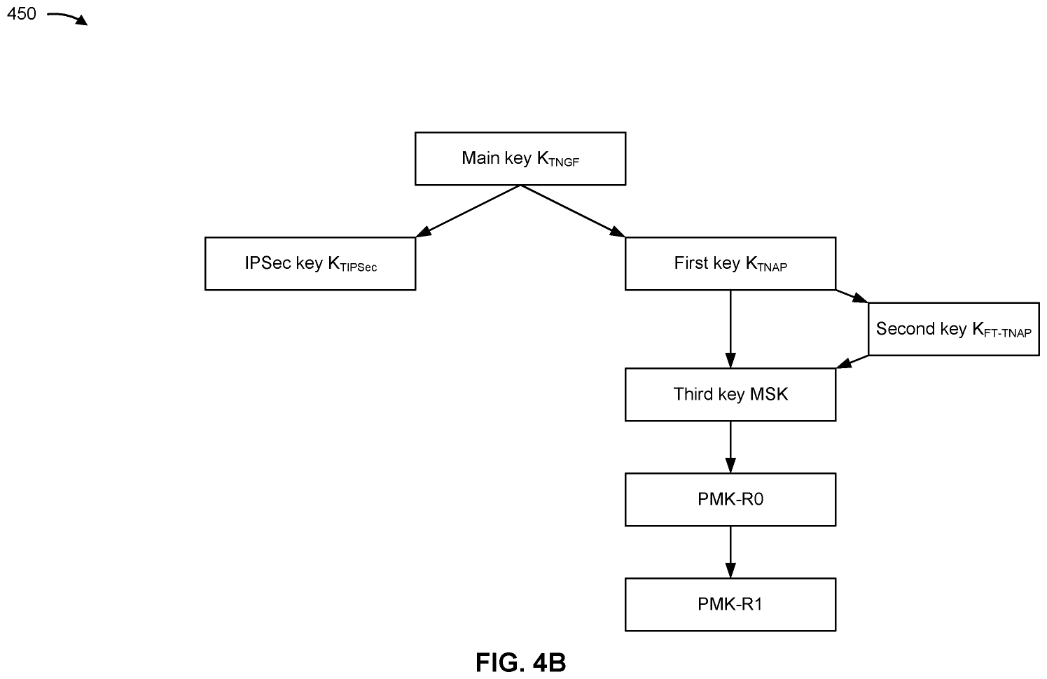

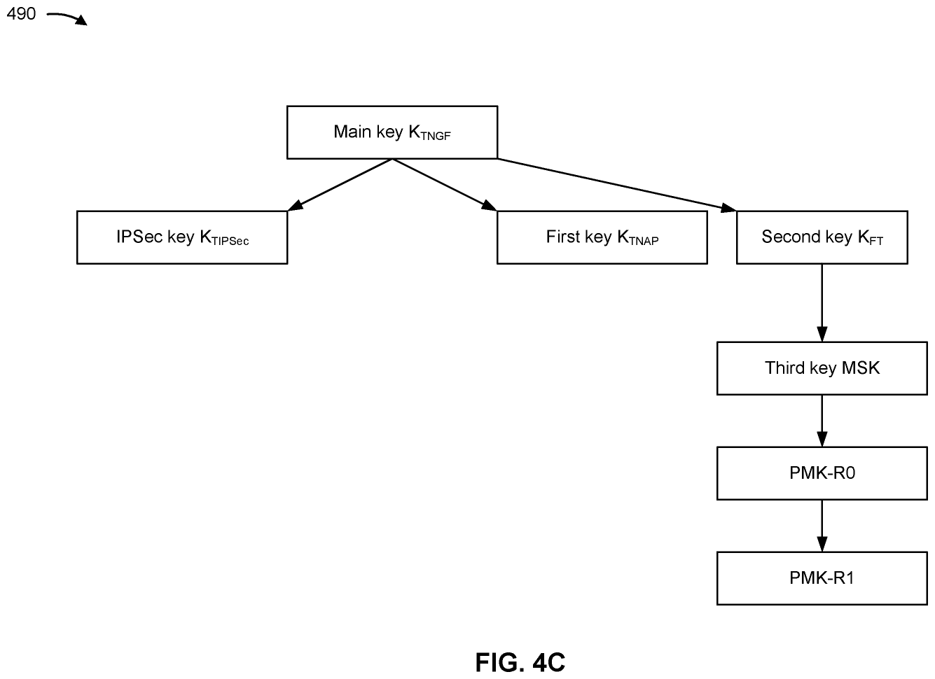

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3, 4A, 4B, 4C 5A, 5B, and 6-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3, 4A, 4B, 4C, 5A, 5B, and 6-12).

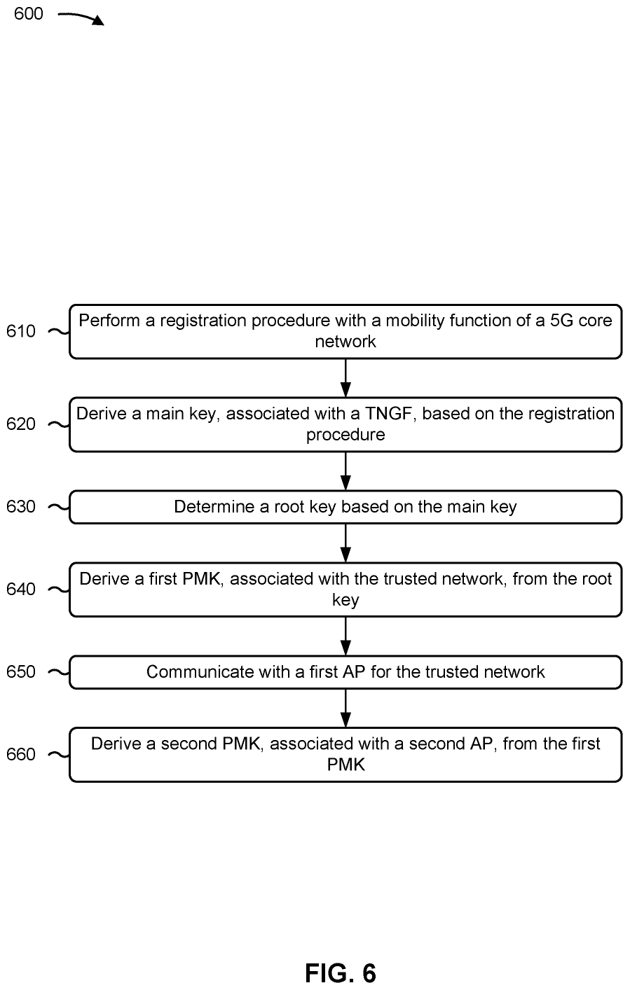

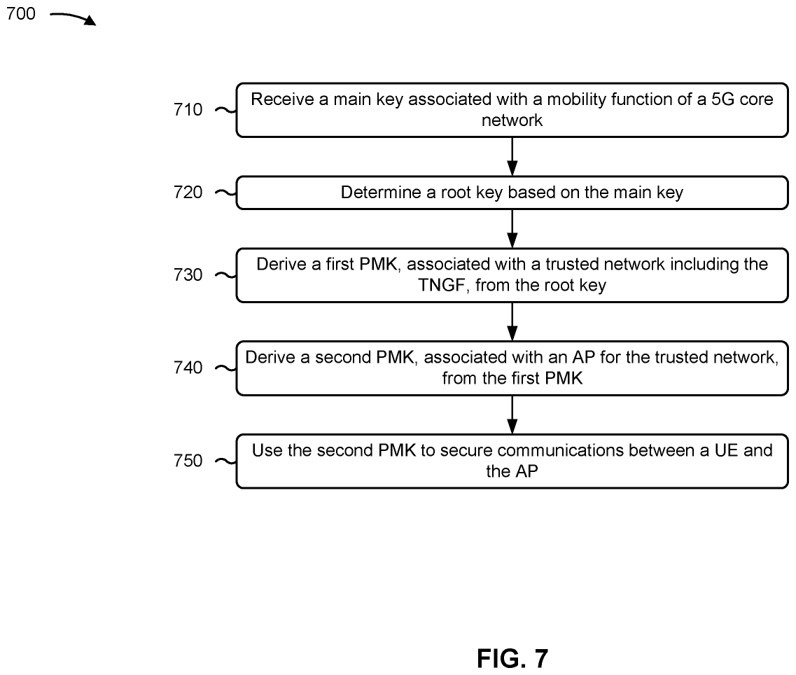

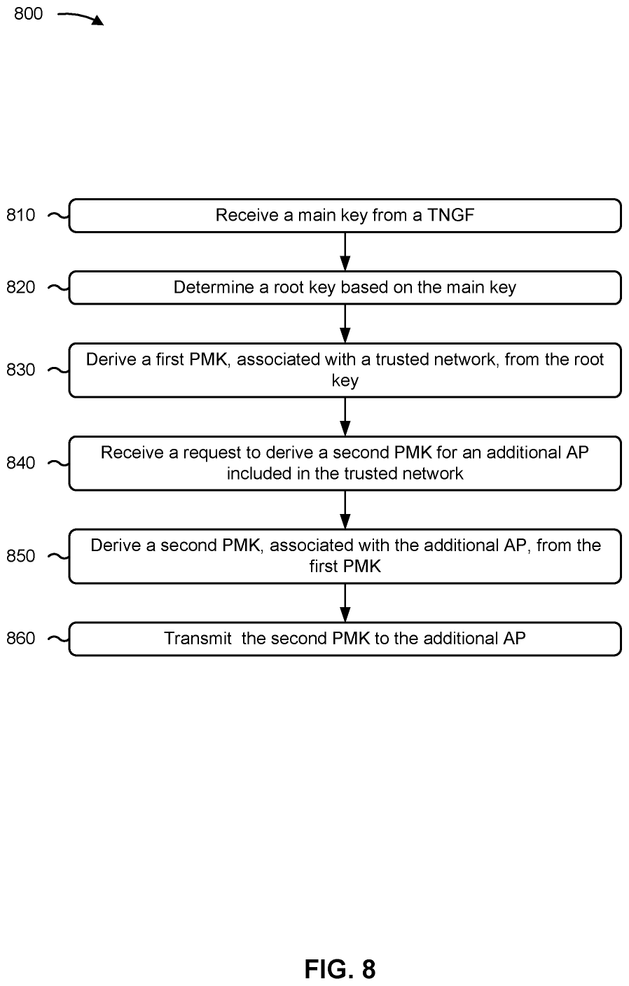

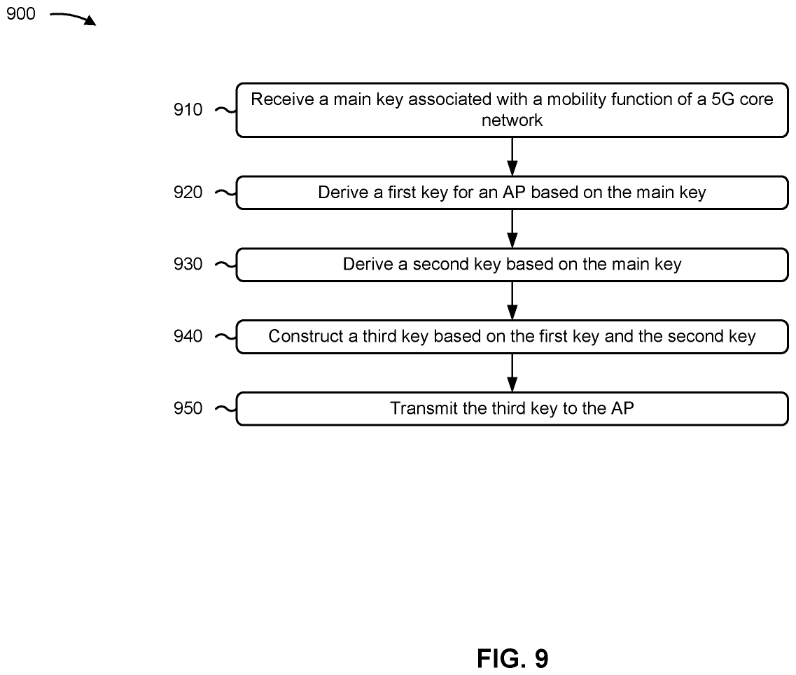

The controller/processor 240 of the network node 110, the controller/processor 280 of the UE 120, and/or any other component(s) of FIG. 2 may perform one or more techniques associated with establishing and using key hierarchies in trusted networks with 5G networks, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples. In some aspects, the AP described herein is the UE 120, is included in the UE 120, or includes one or more components of the UE 120 shown in FIG. 2. In some aspects, the TNGF described herein is the network node 110, is included in the network node 110, or includes one or more components of the network node 110 shown in FIG. 2.

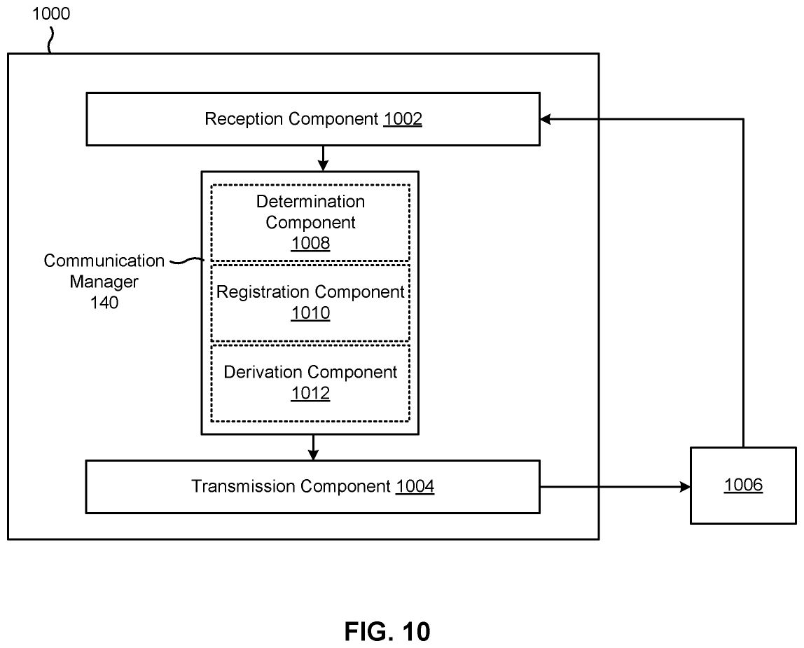

In some aspects, a UE (e.g., the UE 120 and/or apparatus 1000 of FIG. 10) may include means for performing a registration procedure with a mobility function of a 5G core network (e.g., using communication manager 140, antenna 252, modem 254, MIMO detector 256, receive processor 258, transmit processor 264, TX MIMO processor 266, controller/processor 280, or memory 282); means for deriving a main key, associated with a TNGF, based on the registration procedure (e.g., using communication manager 140, controller/processor 280, or memory 282); means for determining a root key based on the main key (e.g., using communication manager 140, controller/processor 280, or memory 282); means for deriving a first PMK, associated with a trusted network, from the root key (e.g., using communication manager 140, controller/processor 280, or memory 282); means for communicating with a first AP for the trusted network (e.g., using communication manager 140, antenna 252, modem 254, MIMO detector 256, receive processor 258, transmit processor 264, TX MIMO processor 266, controller/processor 280, or memory 282); and/or means for deriving a second PMK, associated with a second AP, from the first PMK (e.g., using communication manager 140, controller/processor 280, or memory 282).

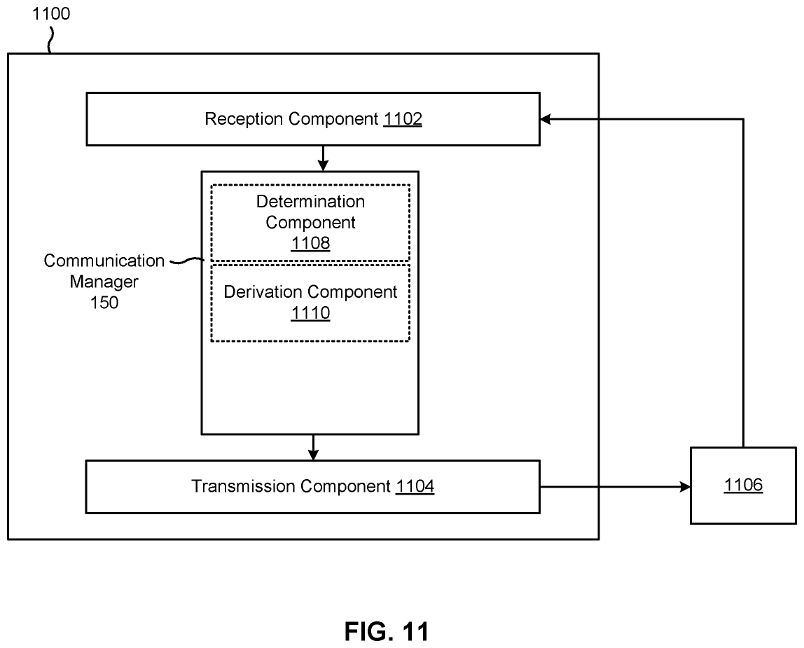

In some aspects, an AP (e.g., AP 310 of FIG. 3 and/or apparatus 1100 of FIG. 11) may include means for receiving a main key from a TNGF (e.g., using communication manager 150, antenna 252, modem 254, MIMO detector 256, receive processor 258, controller/processor 280, or memory 282); means for determining a root key based on the main key (e.g., using communication manager 150, controller/processor 280, or memory 282); means for deriving a first PMK, associated with a trusted network including the AP, from the root key (e.g., using communication manager 150, controller/processor 280, or memory 282); means for receiving a request to derive a second PMK for an additional AP included in the trusted network (e.g., using communication manager 150, antenna 252, modem 254, MIMO detector 256, receive processor 258, controller/processor 280, or memory 282); means for deriving a second PMK, associated with the additional AP, from the first PMK (e.g., using communication manager 150, controller/processor 280, or memory 282); and/or means for transmitting the second PMK to the additional AP (e.g., using communication manager 150, antenna 252, modem 254, transmit processor 264, TX MIMO processor 266, controller/processor 280, or memory 282).

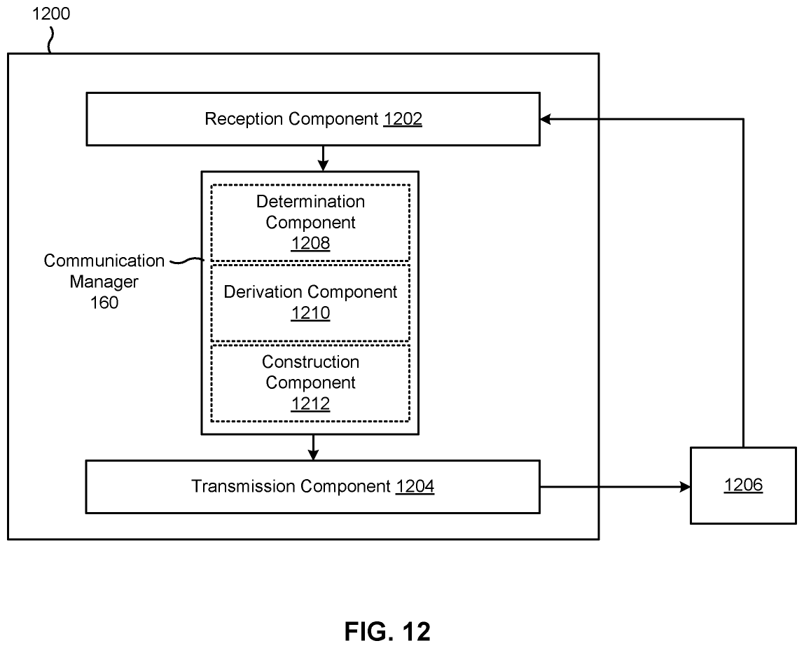

In some aspects, a TNGF (e.g., gateway function 330 of FIG. 3 and/or apparatus 1200 of FIG. 12) may include means for receiving a main key associated with a mobility function of a 5G core network and the TNGF (e.g., using communication manager 160, antenna 234, modem 232, MIMO detector 236, receive processor 238, controller/processor 240, memory 242, or scheduler 246); means for determining a root key based on the main key (e.g., using communication manager 160, controller/processor 240, or memory 242); means for deriving a first PMK, associated with a trusted network including the TNGF, from the root key (e.g., using communication manager 160, controller/processor 240, or memory 242); means for deriving a second PMK, associated with an AP for the trusted network, from the first PMK (e.g., using communication manager 160, controller/processor 240, or memory 242); and/or means for using the second PMK to secure communications between a UE and the AP (e.g., using communication manager 160, transmit processor 220, TX MIMO processor 230, modem 232, antenna 234, controller/processor 240, memory 242, or scheduler 246). Additionally, or alternatively, the TNGF may include means for receiving a main key associated with a mobility function of a 5G core network and the TNGF (e.g., using communication manager 160, antenna 234, modem 232, MIMO detector 236, receive processor 238, controller/processor 240, memory 242, or scheduler 246); means for deriving a first key for an AP based on the main key (e.g., using communication manager 160, controller/processor 240, or memory 242); means for deriving a second key based on the main key (e.g., using communication manager 160, controller/processor 240, or memory 242); means for constructing a third key based on the first key and the second key (e.g., using communication manager 160, controller/processor 240, or memory 242); and/or means for transmitting the third key to the AP (e.g., using communication manager 160, transmit processor 220, TX MIMO processor 230, modem 232, antenna 234, controller/processor 240, memory 242, or scheduler 246).

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an AP, a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

In order to improve quality and reliability of communications and/or reduce latency, a UE may communicate with a core network (e.g., a 5G core network or an LTE core network, among other examples) using a trusted network (e.g., a WiFi network or another type of wired or wireless network). The trusted network may be referred to as a “trusted non-3GPP access network” or “TNAN.” The trusted network may be include a gateway function (also referred to as a “trusted network gateway function” or “TNGF”) that manages communications between the core network and the trusted network. Additionally, the trusted network may include multiple APs.

3GPP specifications have defined a procedure for securing communications between a TNGF and a UE when the UE accesses a core network via the TNGF and an AP included in a same trusted network as the TNGF. However, communications between the UE and the AP should also be secured so that an attacker is unable to intercept and decode the communications. Additionally, when the UE moves from one AP to another AP, the UE repeats the procedure for securing communications between the TNGF and the UE. As a result, the UE wastes a significant amount of power and processing resources. Additionally, the UE consumes network overhead, which increases interference and thus increases latency at nearby devices.

Wireless local area network (WLAN) standards, such as the Institute of Electrical and Electronics Engineers (IEEE) Local Area Network/Metropolitan Area Network (LAN/MAN) Standards Committee's 802.11 standards (also referred to as “IEEE 802.11 protocols”), have defined a procedure for securing communications between an AP and a station (STA) when the STA accesses the AP. However, this procedure is defined with respect to a different architecture than when a UE accesses a core network via a TNGF and an AP. Additionally, when the STA moves from one AP to another AP, IEEE 802.11 protocols define a mobility procedure (referred to as a fast basic service set (BSS) transition (FT) procedure) to conserve power and processing resources at the STA. However, the mobility procedure does not involve a core network or a TNGF, which have separate authentication requirements under 3GPP specifications.

Some techniques and apparatuses described herein enable a UE (e.g., UE 120) to establish a key hierarchy based on a main key derived from a core network. The key hierarchy maps to IEEE 802.11 protocols such that the UE 120 may move between APs of a same mobility domain (e.g., identified by a mobility domain identity (MDID)) without repeating an authentication procedure for securing communications between a AP and the UE 120. The mobility domain may be a trusted non-3GPP access network. APs in the same mobility domain may broadcast a same MDID. As a result, the UE 120 conserves power and processing resources when moving from one AP to another AP. Additionally, the UE 120 conserves network overhead, which reduces interference and thus reduces latency at nearby devices.

FIG. 3 is a diagram illustrating an example of a wireless network 300, in accordance with the present disclosure. The wireless network 300 may be or may include elements of a WLAN, among other examples. The wireless network 300 may include an AP 310 that communicates with a STA 120. The AP 310 and the STA 120 may communicate on a channel using contention-based procedures, such as one or more procedures in the IEEE 802.11 protocols. For example, the STA 120 may transmit data to the AP 310 for the AP 310 to forward to a core network (e.g., including an authentication server 340). The AP 310 may communicate with the core network via an access controller (AC) 320 and a gateway function 330. Accordingly, the AP 310 may be connected to the core network via a wired and/or wireless connection. Similarly, the AP 310 may receive data from a server and/or another remote device, via the core network, for transmission to the STA 120. The STA 120 may be the UE 120 described herein.

In some aspects, an authentication function of the core network may function as the authentication server 340. For example, the authentication function may include an authentication server function (AUSF) of a 5G core network, a home subscriber server (HSS) of a 5G core network, or another similar core network function. The AUSF may include one or more devices that support a process of authenticating the STA 120. The authentication function may communicate with the gateway function 330 via a mobility function of the core network. For example, the mobility function may include an access and mobility management function (AMF) of a 5G core network, a mobility management entity (MME) of a 4G core network, or another similar core network function. The AMF may include one or more devices that act as a termination point for non-access stratum (NAS) signaling and mobility management.

Additionally, a TNGF that manages AP 310 within a mobility domain of a trusted network may be the gateway function 330. The TNGF 330 may use a K_{TIPsec} key to protect integrity of communications with the STA 120 (e.g., using an Internet protocol security (IPSec) secure association (SA) between the STA 120 and the TNGF 330). The K_{TIPsec} key may be based on a K_{TNGF} key from the authentication server 340.

In some aspects, the gateway function 330 may serve as an R0 key holder (R0KH) with respect to IEEE 802.11 protocols. Alternatively, the gateway function 330 may facilitate derivation of an R0 key at a separate R0KH, as described herein. The R0 key may be derived from a root key, where the root key is determined to be the K_{TNGF} key or is a K_{FT} key that is itself derived from the K_{TNGF} key. In some aspects, the TNGF may derive a master session key (MSK) from a K_{TNAP} key (e.g., derived from the K_{TNGF} key) and/or the K_{FT} key, such that the AP 310 may use the MSK to derive an R1 key, as described below. Alternatively, the AP 310 may derive the MSK from the K_{TNAP} key and/or the K_{FT} key.

In some aspects, the AC 320 may be separate (e.g., physically, logically, and/or virtually) from the gateway function 330. Accordingly, the AC 320 may serve as the R0KH with respect to IEEE 802.11 protocols. Alternatively, the AC 320 may be at least partially integrated with the gateway function 330. Alternatively, the AC 320 may be co-located with the AP 310. Accordingly, the AP 310 may serve as the R0KH with respect to IEEE 802.11 protocols. The AP 310 may additionally serve as the R1KH with respect to IEEE 802.11 protocols. Accordingly, communications between the AP 310 and the STA 120 are secure by the R1 key.

In some aspects, as shown in FIG. 3, the AP 310 may include a communication manager 150. As described in more detail elsewhere herein, the communication manager 150 may receive a main key from the TNGF 330; determine a root key based on the main key; derive a first PMK, associated with a trusted network including the AP 310, from the root key; receive a request to derive a second PMK for an additional AP included in the trusted network; derive a second PMK, associated with the additional AP, from the first PMK; and transmit the second PMK to the additional AP. Additionally, or alternatively, the communication manager 150 may perform one or more other operations described herein.

In some aspects, as shown in FIG. 3, the TNGF 330 may include a communication manager 160. As described in more detail elsewhere herein, the communication manager 160 may receive a main key associated with a mobility function of a 5G core network and the TNGF; determine a root key based on the main key; derive a first PMK, associated with a trusted network including the TNGF 330, from the root key; derive a second PMK, associated with the AP 310 for the trusted network, from the first PMK; and use the second PMK to secure communications between the STA 120 and the AP 310. Alternatively, as described in more detail elsewhere herein, the communication manager 160 may receive a main key associated with a mobility function of a 5G core network and the TNGF 330; derive a first key for the AP 310 based on the main key; derive a second key based on the main key; construct a third key based on the first key and the second key; and transmit the third key to the AP 310. Additionally, or alternatively, the communication manager 160 may perform one or more other operations described herein.

As indicated above, FIG. 3 is provided as an example. Other examples may differ from what is described with regard to FIG. 3.

FIG. 4A is a diagram illustrating an example 400 associated with a key hierarchy for a trusted network with a 5G network, in accordance with the present disclosure. As shown in FIG. 4A, example 400 includes a main key (e.g., represented by K_{TNGF}, as defined in 3GPP specifications) that is derived from a registration procedure (e.g., an authentication procedure) between a UE (e.g., UE 120) and a mobility function of a 5G core network (e.g., 5G network 501). Accordingly, the mobility function may provide the main key to a TNGF (e.g., TNGF 330) of a trusted network that will communicate with the UE. The TNGF 330 may establish an IPSec SA with the UE 120 with an IPSec key (e.g., represented by K_{TIPsec}, as defined in 3GPP specifications). The IPSec key may be derived from the main key, as shown in FIG. 4A.

As further shown in FIG. 4A, a first key (e.g., represented by K_{TNAP}, as defined in 3GPP specifications) may be derived from the main key. Therefore, a root key (e.g., represented by XXKey, as defined in IEEE 802.11 protocols) may be based on the first key or on the main key. For example, a key derivation function (KDF) may be applied to the main key (e.g., represented by KDF(K_{TNAP}, S), where S is an input to the KDF). In some aspects, the root key may be based on the main key and a usage type distinguisher (e.g., a value of 0×03 or another value to be defined in 3GPP specifications). Alternatively, the root key may be represented by K_{FT-TNAP} (e.g., to be defined in 3GPP specifications), where K_{FT-TNAP} represents a derivation from the first key K_{TNAP} (e.g., using a usage type distinguisher, such as a value of 0×03 or another value to be defined in 3GPP specifications).

Therefore, as further shown in FIG. 4A, the root key may be used to derive a first PMK (e.g., PMK-R0, as defined in IEEE 802.11 protocols). Moreover, the first PMK may be used to derive a second PMK (e.g., PMK-R1, as defined in IEEE 802.11 protocols). The PMK-R1 may therefore be used to secure communications between an AP (e.g., AP 310) and the UE 120.

FIG. 4B is a diagram illustrating an example 450 associated with a key hierarchy for a trusted network with a 5G network, in accordance with the present disclosure. As shown in FIG. 4B, example 450 includes a main key (e.g., represented by K_{TNGF}, as defined in 3GPP specifications) that is derived from a registration procedure (e.g., an authentication procedure) between a UE (e.g., UE 120) and a mobility function of a 5G core network (e.g., 5G network 501). Accordingly, the mobility function may provide the main key to a TNGF (e.g., TNGF 330) of a trusted network that will communicate with the UE. The TNGF 330 may establish an IPSec SA with the UE 120 with an IPSec key (e.g., represented by K_{TIPsec}, as defined in 3GPP specifications). The IPSec key may be derived from the main key, as shown in FIG. 4B.

As further shown in FIG. 4B, a first key (e.g., represented by K_{TNAP}, as defined in 3GPP specifications) may be derived from the main key. Additionally, a second key (e.g., represented by K_{FT-TNAP}, to be defined in 3GPP specifications) may be based on the first key. For example, a KDF may be applied to the first key. Therefore, a third key (e.g., represented by MSK, as defined in 3GPP specifications) may be based on the first key and the second key. For example, the third key may be a concatenation of the first key with the second key (e.g., a concatenation of the key represented by K_{TNAP}, as defined in 3GPP specifications, with the key represented by K_{FT-TNAP}, to be defined in 3GPP specifications).

Therefore, as further shown in FIG. 4B, the third key may be used to derive a first PMK (e.g., PMK-R0, as defined in IEEE 802.11 protocols). Moreover, the first PMK may be used to derive a second PMK (e.g., PMK-R1, as defined in IEEE 802.11 protocols). The PMK-R1 may therefore be used to secure communications between an AP (e.g., AP 310) and the UE 120.

FIG. 4C is a diagram illustrating an example 490 associated with a key hierarchy for a trusted network with a 5G network, in accordance with the present disclosure. As shown in FIG. 4C, example 490 includes a main key (e.g., represented by K_{TNGF}, as defined in 3GPP specifications) that is derived from a registration procedure (e.g., an authentication procedure) between a UE (e.g., UE 120) and a mobility function of a 5G core network (e.g., 5G network 501). Accordingly, the mobility function may provide the main key to a TNGF (e.g., TNGF 330) of a trusted network that will communicate with the UE. The TNGF 330 may establish an IPSec SA with the UE 120 with an IPSec key (e.g., represented by K_{TIPsec}, as defined in 3GPP specifications). The IPSec key may be derived from the main key, as shown in FIG. 4C.

As further shown in FIG. 4C, a first key (e.g., represented by K_{TNAP}, as defined in 3GPP specifications) may be derived from the main key. Additionally, a second key (e.g., represented by K_{FT}, to be defined in 3GPP specifications) may be derived from the main key (e.g., using a different usage type distinguisher for the second key as for the first key). In other words, the second key may be taken as the master PMK (MPMK) from which an FT hierarchy may be established. For example, a third key (e.g., represented by MSK, as defined in 3GPP specifications) may be based on the second key.

Therefore, as further shown in FIG. 4C, the third key may be used to derive a first PMK (e.g., PMK-R0, as defined in IEEE 802.11 protocols). Moreover, the first PMK may be used to derive a second PMK (e.g., PMK-R1, as defined in IEEE 802.11 protocols). The PMK-R1 may therefore be used to secure communications between an AP (e.g., AP 310) and the UE 120.

By using techniques as described in connection with FIGS. 4A-4C, a key hierarchy is established based on a main key from the core network. The key hierarchy maps to IEEE 802.11 protocols such that the UE 120 may move between APs of the trusted network without repeating a procedure for securing communications between the TNGF 330 and the UE 120. As a result, the UE 120 conserves power and processing resources when moving from one AP to another AP. Additionally, the UE 120 conserves network overhead, which reduces interference and thus reduces latency at nearby devices.

As indicated above, FIGS. 4A, 4B, and 4C are provided as examples. Other examples may differ from what is described with respect to FIGS. 4A, 4B, and 4C.

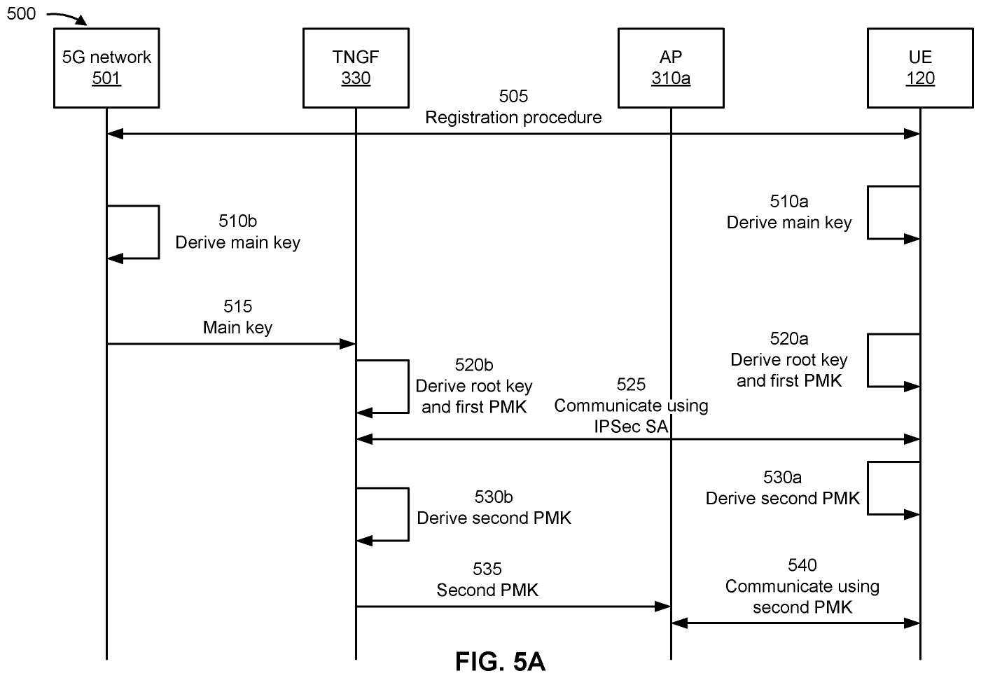

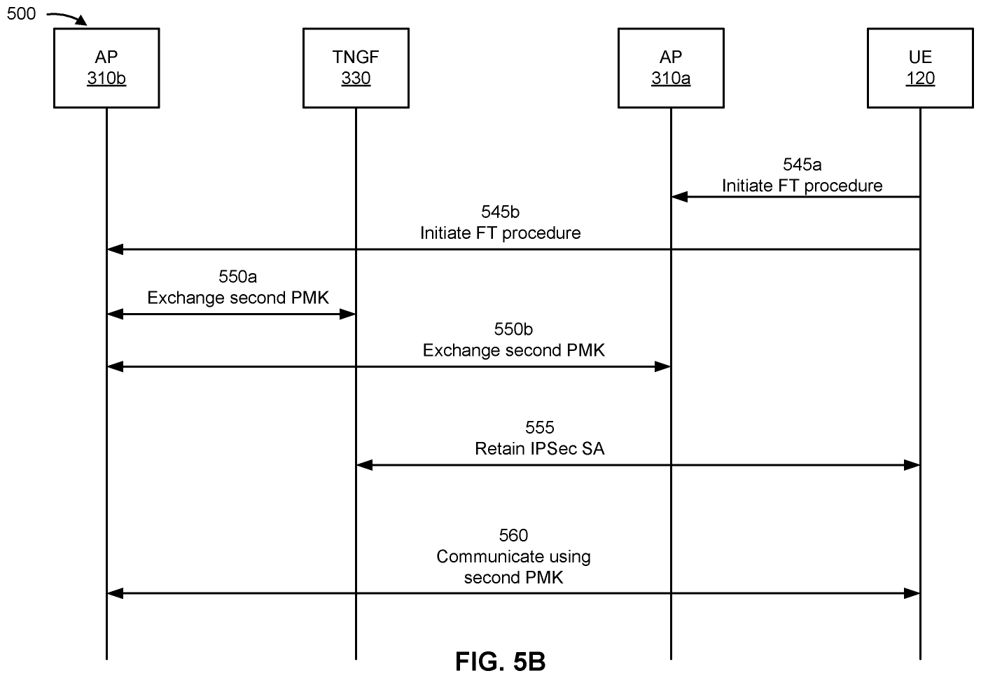

FIGS. 5A and 5B are diagrams illustrating an example 500 associated with mobility in a trusted network used to access a 5G network, in accordance with the present disclosure. As shown in FIG. 5A, a UE 120 may determine to access a 5G network 501 via a trusted network. For example, the UE 120 may determine that a channel condition with a cellular network (e.g., wireless network 100 of FIG. 1) fails to satisfy a reliability threshold and determine to use the trusted network based on the channel condition failing to satisfy the reliability threshold. The trusted network may include a TNGF 330 that controls a plurality of APs (e.g., AP 310a and AP 310b). The UE 120 may determine to access the AP 310a. For example, the UE 120 may determine that a measurement with an AP 310a satisfies a measurement threshold and determine to use the AP 310a based on the measurement satisfying the measurement threshold.

As shown in FIG. 5A and by reference number 505, the UE 120 may perform a registration procedure with the 5G network 501. For example, the UE 120 may perform an authentication procedure with the 5G network 501 in order to trigger generation of a key hierarchy (e.g., as described in connection with FIG. 4A, FIG. 4B, or FIG. 4C) for securing communications with the trusted network.

Accordingly, as shown by reference number 510a, the UE 120 may derive a main key based on the registration procedure. Similarly, as shown by reference number 510b, the 5G network 501 may derive the main key as well. The main key may be represented by K_{TNGF}, as defined in 3GPP specifications.

As shown by reference number 515, the 5G network 501 may transmit the main key to the TNGF 330 of the trusted network. Therefore, the TNGF 330 may continue constructing the key hierarchy with the UE 120.

Accordingly, as shown by reference number 520a, the UE 120 may determine a root key based on the main key as well as derive a first PMK based on the root key. Similarly, as shown by reference number 520b, the TNGF 330 may determine the root key and the first PMK. The root key may be represented by XXKey, and the first PMK may be represented by PMK-R0, as defined in IEEE 802.11 protocols. Although example 500 is shown with the TNGF 330 deriving PMK-R0, other examples may instead have the AP 310a receive the root key from the TNGF 330 and derive the PMK-R0. Alternatively, other examples may instead have an AC 320 (e.g., separate from, or co-located with, the AP 310a) receive the root key from the TNGF 330 and derive the PMK-R0. Accordingly, any of the TNGF 330, the AC 320, and/or the AP 310a may function as the R0KH, in accordance with IEEE 802.11 protocols.

As shown by reference number 525, the UE 120 and the TNGF 330 may establish an IPSec SA. Accordingly, the UE 120 and the TNGF 330 may communicate with integrity protection using the IPSec SA. The IPSec SA may be established using a key derived from the main key (e.g., using a key represented by K_{TIPsec}, as defined in 3GPP specifications).

As shown by reference number 530a, the UE 120 may further derive a second PMK based on the first PMK. Similarly, as shown by reference number 530b, the TNGF 330 may derive the second PMK based on the first PMK. The first PMK may be represented by PMK-R0, and the second PMK may be represented by PMK-R1, as defined in IEEE 802.11 protocols.

As shown by reference number 535, the TNGF 330 may provide the second PMK to the AP 310a. Although example 500 is shown with the TNGF 330 providing PMK-R1, other examples may instead have the AP 310a receive the PMK-R0 from the TNGF 330 and derive the PMK-R1. Alternatively, other examples may instead have an AC 320 (e.g., separate from, or co-located with, the AP 310a) receive the PMK-R0 from the TNGF 330 and derive the PMK-R1. Accordingly, any of the TNGF 330, the AC 320, and/or the AP 310a may function as the R0KH, in accordance with IEEE 802.11 protocols.

Although example 500 is described using a root key, the UE 120 and the TNGF 330 may instead derive a first key (e.g., represented by K_{TNAP}, as defined in 3GPP specifications) based on the main key, derive a second key (e.g., represented by K_{FT-TNAP} or K_{FT}, to be defined in 3GPP specifications), and determine a third key based on the first key and the second key (e.g., by concatenating the first key with the second key). Accordingly, the third key may be an MSK, as defined in IEEE 802.11 protocols, and may be used by the TNGF 330 and the UE 120 to derive the PMK-R0. Similarly, the TNGF 330 (and/or the AP 310a) may use the MSK to derive PMK-R1.

As shown by reference number 540, the UE 120 and the AP 310a may communicate using encryption with the second PMK. Accordingly, communications between the UE 120 and the AP 310a are secure.

When the UE 120 moves within the trusted network, the UE 120 may determine to access a different AP. For example, the UE 120 may determine that a measurement with an AP 310b satisfies a measurement threshold and determine to use the AP 310b based on the measurement satisfying the measurement threshold.

Therefore, as shown in FIG. 5B and by reference number 545a, the UE 120 may initiate an FT procedure with the AP 310a. Accordingly, the UE 120 and the AP 310a may perform an over-the-DS FT procedure, as defined in IEEE 802.11 protocols.

Alternatively, as shown in FIG. 5B and by reference number 545b, the UE 120 may initiate an FT procedure with the AP 310b. Accordingly, the UE 120 and the AP 310b may perform an over-the-air FT procedure, as defined in IEEE 802.11 protocols.

As shown by reference number 550a, the AP 310b may request, and the TNGF 330 may transmit, the second PMK to use with the UE 120. Accordingly, the TNGF 330 may function as the R0KH. Alternatively, as shown by reference number 550b, the AP 310b may request, and the AP 310a may transmit, the second PMK to use with the UE 120. Accordingly, the AP 310a (or an AC 320 co-located therewith) may function as the R0KH. Alternatively, a separate AC 320 may provide the second PMK to the AP 310b to use with the UE 120.

Accordingly, as shown by reference number 555, the TNGF 330 may retain the IPSec SA with the UE 120. As a result, the UE 120 and the TNGF 330 conserve power and processing resources as compared with re-establishing the IPSec SA (e.g., using a procedure defined in 3GPP specifications).

Additionally, as shown by reference number 560, the UE 120 and the AP 310b may communicate using encryption with the second PMK. Accordingly, communications between the UE 120 and the AP 310b are secure.

By using techniques as described in connection with FIG. 5, the UE 120 may move between APs 310a and 310b of the trusted network without repeating a procedure for securing communications between the TNGF 330 and the UE 120. As a result, the UE 120 conserves power and processing resources when moving from the AP 310a to the AP 310b. Additionally, the UE 120 conserves network overhead, which reduces interference and thus reduces latency at nearby devices.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120 and/or apparatus 1000 of FIG. 10) performs operations associated with establishing key hierarchies in trusted networks with 5G networks.

As shown in FIG. 6, in some aspects, process 600 may include performing a registration procedure with a mobility function of a 5G core network (block 610). For example, the UE (e.g., using communication manager 140 and/or registration component 1010, depicted in FIG. 10) may perform a registration procedure with a mobility function of a 5G core network, as described herein, for example, with reference to FIGS. 3, 4A, 4B, 4C, 5A, and/or 5B.

As further shown in FIG. 6, in some aspects, process 600 may include deriving a main key, associated with a TNGF, based on the registration procedure (block 620). For example, the UE (e.g., using communication manager 140 and/or derivation component 1012, depicted in FIG. 10) may derive a main key, associated with a TNGF, based on the registration procedure, as described herein, for example, with reference to FIGS. 3, 4A, 4B, 4C, 5A, and/or 5B.

As further shown in FIG. 6, in some aspects, process 600 may include determining a root key based on the main key (block 630). For example, the UE (e.g., using communication manager 140 and/or determination component 1008, depicted in FIG. 10) may determine a root key based on the main key, as described herein, for example, with reference to FIGS. 3, 4A, 4B, 4C, 5A, and/or 5B.

As further shown in FIG. 6, in some aspects, process 600 may include deriving a first PMK, associated with a trusted network, from the root key (block 640). For example, the UE (e.g., using communication manager 140 and/or derivation component 1012) may derive a first PMK, associated with a trusted network, from the root key, as described herein, for example, with reference to FIGS. 3, 4A, 4B, 4C, 5A, and/or 5B.

As further shown in FIG. 6, in some aspects, process 600 may include communicating with a first AP for the trusted network (block 650). For example, the UE (e.g., using communication manager 140, reception component 1002, and/or transmission component 1004, as depicted in FIG. 10) may communicate with a first AP for the trusted network, as described herein, for example, with reference to FIGS. 3, 4A, 4B, 4C, 5A, and/or 5B.

As further shown in FIG. 6, in some aspects, process 600 may include deriving a second PMK, associated with a second AP, from the first PMK (block 660). For example, the UE (e.g., using communication manager 140 and/or derivation component 1012) may derive a second PMK, associated with a second AP, from the first PMK, as described herein, for example, with reference to FIGS. 3, 4A, 4B, 4C, 5A, and/or 5B.

Process 600 may include additional aspects, such as any single aspect or any combination of aspects described below and/or in connection with one or more other processes described elsewhere herein.

In a first aspect, the registration procedure includes an authentication procedure.

In a second aspect, alone or in combination with the first aspect, the mobility function includes an AMF.

In a third aspect, alone or in combination with one or more of the first and second aspects, process 600 includes determining (e.g., using communication manager 140 and/or determination component 1008) to access the trusted network, determining (e.g., using communication manager 140 and/or determination component 1008) to access the first AP, and determining (e.g., using communication manager 140 and/or determination component 1008) to access the second AP for the trusted network.

In a fourth aspect, alone or in combination with one or more of the first through third aspects, determining to access the second AP includes receiving (e.g., using communication manager 140 and/or reception component 1002) a broadcast from the second AP, and determining (e.g., using communication manager 140 and/or determination component 1008) that the second AP is in a same trusted network as the first AP based on an MDID indicated in the broadcast.

In a fifth aspect, alone or in combination with one or more of the first through fourth aspects, the main key is a K_{TNGF} key.

In a sixth aspect, alone or in combination with one or more of the first through fifth aspects, the root key is an XXKey.

In a seventh aspect, alone or in combination with one or more of the first through sixth aspects, determining the root key includes applying a KDF to the main key to determine the root key.

In an eighth aspect, alone or in combination with one or more of the first through seventh aspects, determining the root key includes deriving the root key from the main key based on a usage type distinguisher.

In a ninth aspect, alone or in combination with one or more of the first through eighth aspects, determining the root key includes deriving a first key from the main key based on a first usage type distinguisher and deriving a second key from the main key based on a second usage type distinguisher, such that the root key is determined based on the first key and the second key.

In a tenth aspect, alone or in combination with one or more of the first through ninth aspects, the root key is a master session key (MSK).

In an eleventh aspect, alone or in combination with one or more of the first through tenth aspects, the root key is a concatenation of the first key with the second key

In a twelfth aspect, alone or in combination with one or more of the first through eleventh aspects, the root key is a K_{FT} key.

In a thirteenth aspect, alone or in combination with one or more of the first through twelfth aspects, the first PMK is a PMK-R0.

In a fourteenth aspect, alone or in combination with one or more of the first through thirteenth aspects, the second PMK is a PMK-R1.

In a fifteenth aspect, alone or in combination with one or more of the first through fourteenth aspects, process 600 includes transmitting to (e.g., using communication manager 140 and/or transmission component 1004, depicted in FIG. 10), or receiving from (e.g., using communication manager 140 and/or reception component 1002), the second AP using encryption based on the second PMK.

In a sixteenth aspect, alone or in combination with one or more of the first through fifteenth aspects, process 600 includes transmitting (e.g., using communication manager 140 and/or transmission component 1004), to the second AP, an authentication request; transmitting (e.g., using communication manager 140 and/or transmission component 1004), to the second AP, a reassociation request based on a response to the authentication request; and transmitting to (e.g., using communication manager 140 and/or transmission component 1004), or receiving from (e.g., using communication manager 140 and/or reception component 1002), the second AP using encryption based on the second PMK.

In a seventeenth aspect, alone or in combination with one or more of the first through sixteenth aspects, process 600 includes transmitting (e.g., using communication manager 140 and/or transmission component 1004), to the first AP, an FT request; transmitting (e.g., using communication manager 140 and/or transmission component 1004), to the second AP, a reassociation request based on a response to the FT request; and transmitting to (e.g., using communication manager 140 and/or transmission component 1004), or receiving from (e.g., using communication manager 140 and/or reception component 1002), the second AP using encryption based on the second PMK.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a TNGF, in accordance with the present disclosure. Example process 700 is an example where the TNGF (e.g., TNGF 330 and/or apparatus 1200 of FIG. 12) performs operations associated with establishing key hierarchies in trusted networks with 5G networks.

As shown in FIG. 7, in some aspects, process 700 may include receiving a main key associated with a mobility function of a 5G core network and the TNGF (block 710). For example, the TNGF (e.g., using communication manager 160 and/or reception component 1202, depicted in FIG. 12) may receive a main key associated with a mobility function of a 5G core network and the TNGF, as described herein, for example, with reference to FIGS. 3, 4A, 4B, 4C, 5A, and/or 5B.

As further shown in FIG. 7, in some aspects, process 700 may include determining a root key based on the main key (block 720). For example, the TNGF (e.g., using communication manager 160 and/or determination component 1208, depicted in FIG. 12) may determine a root key based on the main key, as described herein, for example, with reference to FIGS. 3, 4A, 4B, 4C, 5A, and/or 5B.

As further shown in FIG. 7, in some aspects, process 700 may include deriving a first PMK, associated with a trusted network including the TNGF, from the root key (block 730). For example, the TNGF (e.g., using communication manager 160 and/or derivation component 1210, depicted in FIG. 12) may derive a first PMK, associated with a trusted network including the TNGF, from the root key, as described herein, for example, with reference to FIGS. 3, 4A, 4B, 4C, 5A, and/or 5B.

As further shown in FIG. 7, in some aspects, process 700 may include deriving a second PMK, associated with an AP for the trusted network, from the first PMK (block 740). For example, the TNGF (e.g., using communication manager 160 and/or derivation component 1210) may derive a second PMK, associated with an AP for the trusted network, from the first PMK, as described herein, for example, with reference to FIGS. 3, 4A, 4B, 4C, 5A, and/or 5B.

As further shown in FIG. 7, in some aspects, process 700 may include using the second PMK to secure communications between a UE and the AP (block 750). For example, the TNGF (e.g., using communication manager 160 and/or transmission component 1204, depicted in FIG. 12) may use the second PMK to secure communications between a UE and the AP, as described herein, for example, with reference to FIGS. 3, 4A, 4B, 4C, 5A, and/or 5B.

Process 700 may include additional aspects, such as any single aspect or any combination of aspects described below and/or in connection with one or more other processes described elsewhere herein.

In a first aspect, the mobility function includes an AMF.

In a second aspect, alone or in combination with the first aspect, the main key is a K_{TNGF} key.

In a third aspect, alone or in combination with one or more of the first and second aspects, the root key is an XXKey.

In a fourth aspect, alone or in combination with one or more of the first through third aspects, determining the root key includes applying a KDF to the main key to determine the root key.

In a fifth aspect, alone or in combination with one or more of the first through fourth aspects, determining the root key includes deriving the root key from the main key based on a usage type distinguisher.

In a sixth aspect, alone or in combination with one or more of the first through fifth aspects, the root key is a K_{FT} key.

In a seventh aspect, alone or in combination with one or more of the first through sixth aspects, the first PMK is a PMK-R0.

In an eighth aspect, alone or in combination with one or more of the first through seventh aspects, using the second PMK to secure communications includes transmitting the second PMK to the AP.

In a ninth aspect, alone or in combination with one or more of the first through eighth aspects, using the second PMK to secure communications includes transmitting the first PMK to an AC, associated with the AP, for deriving the second PMK.

In a tenth aspect, alone or in combination with one or more of the first through ninth aspects, using the PMK to secure communications includes transmitting the first PMK to the AP for deriving the second PMK.

In an eleventh aspect, alone or in combination with one or more of the first through tenth aspects, process 700 includes transmitting to (e.g., using communication manager 160 and/or transmission component 1204), or receiving from (e.g., using communication manager 160 and/or reception component 1202, depicted in FIG. 12), the UE using integrity protection based on an IPSec SA between the UE and the TNGF.

In a twelfth aspect, alone or in combination with one or more of the first through eleventh aspects, process 700 includes receiving (e.g., using communication manager 160 and/or reception component 1202), from a target AP, a request for an additional PMK derived from the first PMK, and transmitting (e.g., using communication manager 160 and/or transmission component 1204), to the target AP, the additional PMK in response to the request.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by an AP, in accordance with the present disclosure. Example process 800 is an example where the AP (e.g., AP 310 and/or apparatus 1100 of FIG. 11) performs operations associated with using key hierarchies in trusted networks with 5G networks.

As shown in FIG. 8, in some aspects, process 800 may include receiving a main key from a trusted network gateway function (TNGF) (block 810). For example, the AP (e.g., using communication manager 150 and/or reception component 1102, depicted in FIG. 11) may receive a main key from a TNGF, as described herein, for example, with reference to FIGS. 3, 4A, 4B, 4C, 5A, and/or 5B.

As further shown in FIG. 8, in some aspects, process 800 may include determining a root key based on the main key (block 820). For example, the AP (e.g., using communication manager 150 and/or determination component 1108, depicted in FIG. 11) may determine a root key based on the main key, as described herein, for example, with reference to FIGS. 3, 4A, 4B, 4C, 5A, and/or 5B.

As further shown in FIG. 8, in some aspects, process 800 may include deriving a first PMK, associated with a trusted network including the AP, from the root key (block 830). For example, the AP (e.g., using communication manager 150 and/or derivation component 1110, depicted in FIG. 11) may derive a first PMK, associated with a trusted network including the AP, from the root key, as described herein, for example, with reference to FIGS. 3, 4A, 4B, 4C, 5A, and/or 5B.

As further shown in FIG. 8, in some aspects, process 800 may include receiving a request to derive a second PMK for an additional AP included in the trusted network (block 840). For example, the AP (e.g., using communication manager 150 and/or reception component 1102) may receive a request to derive a second PMK for an additional AP included in the trusted network, as described herein, for example, with reference to FIGS. 3, 4A, 4B, 4C, 5A, and/or 5B.

As further shown in FIG. 8, in some aspects, process 800 may include deriving a second PMK, associated with the additional AP, from the first PMK (block 850). For example, the AP (e.g., using communication manager 160 and/or derivation component 1110) may derive a second PMK, associated with the additional AP, from the first PMK, as described herein, for example, with reference to FIGS. 3, 4A, 4B, 4C, 5A, and/or 5B.

As further shown in FIG. 8, in some aspects, process 800 may include transmitting the second PMK to the additional AP (block 860). For example, the AP (e.g., using communication manager 150 and/or transmission component 1104, depicted in FIG. 11) may transmit the second PMK to the additional AP, as described herein, for example, with reference to FIGS. 3, 4A, 4B, 4C, 5A, and/or 5B.

Process 800 may include additional aspects, such as any single aspect or any combination of aspects described below and/or in connection with one or more other processes described elsewhere herein.

In a first aspect, the root key is an XXKey.

In a second aspect, alone or in combination with the first aspect, the root key is a K_{FT} key.

In a third aspect, alone or in combination with one or more of the first and second aspects, the first PMK is a PMK-R0.

In a fourth aspect, alone or in combination with one or more of the first through third aspects, the second PMK is a PMK-R1.

In a fifth aspect, alone or in combination with one or more of the first through fourth aspects, process 800 includes transmitting to (e.g., using communication manager 150 and/or transmission component 1104), or receiving from (e.g., using communication manager 150 and/or reception component 1102), a UE using encryption based on the second PMK.

In a sixth aspect, alone or in combination with one or more of the first through fifth aspects, the main key is received via an AC.

In a seventh aspect, alone or in combination with one or more of the first through sixth aspects, the main key is received at an AC co-located with the AP.

In an eighth aspect, alone or in combination with one or more of the first through seventh aspects, the request is received from a UE, and process 800 includes transmitting (e.g., using communication manager 150 and/or transmission component 1104), to the additional AP, the FT request; receiving (e.g., using communication manager 150 and/or reception component 1102), from the additional AP, a response to the FT request; and transmitting (e.g., using communication manager 150 and/or transmission component 1104), to the UE, the response to the FT request.

In a ninth aspect, alone or in combination with one or more of the first through eighth aspects, the request is received from the additional AP.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a TNGF, in accordance with the present disclosure. Example process 900 is an example where the TNGF (e.g., TNGF 330 and/or apparatus 1200 of FIG. 12) performs operations associated with establishing key hierarchies in trusted networks with 5G networks.

As shown in FIG. 9, in some aspects, process 900 may include receiving a main key associated with a mobility function of a 5G core network (block 910). For example, the TNGF (e.g., using communication manager 160 and/or reception component 1202, depicted in FIG. 12) may receive a main key associated with a mobility function of a 5G core network, as described herein, for example, with reference to FIGS. 3, 4A, 4B, 4C, 5A, and/or 5B.

As further shown in FIG. 9, in some aspects, process 900 may include deriving a first key for an AP based on the main key (block 920). For example, the TNGF (e.g., using communication manager 160 and/or derivation component 1210, depicted in FIG. 12) may derive a first key for an AP based on the main key, as described herein, for example, with reference to FIGS. 3, 4A, 4B, 4C, 5A, and/or 5B.

As further shown in FIG. 9, in some aspects, process 900 may include deriving a second key based on the main key (block 930). For example, the TNGF (e.g., using communication manager 160 and/or derivation component 1210) may derive a second key based on the main key, as described herein, for example, with reference to FIGS. 3, 4A, 4B, 4C, 5A, and/or 5B.

As further shown in FIG. 9, in some aspects, process 900 may include constructing a third key based on the first key and the second key (block 940). For example, the TNGF (e.g., using communication manager 160 and/or construction component 1212) may construct a third key based on the first key and the second key, as described herein, for example, with reference to FIGS. 3, 4A, 4B, 4C, 5A, and/or 5B.

As further shown in FIG. 9, in some aspects, process 900 may include transmitting the third key to the AP (block 950). For example, the TNGF (e.g., using communication manager 160 and/or transmission component 1204, depicted in FIG. 12) may transmit the third key to the AP, as described herein, for example, with reference to FIGS. 3, 4A, 4B, 4C, 5A, and/or 5B.

Process 900 may include additional aspects, such as any single aspect or any combination of aspects described below and/or in connection with one or more other processes described elsewhere herein.

In a first aspect, the first key is a K_{TNAP} key.

In a second aspect, alone or in combination with the first aspect, the second key is a K_{FT} key.

In a third aspect, alone or in combination with one or more of the first and second aspects, the third key is an MSK.

In a fourth aspect, alone or in combination with one or more of the first through third aspects, constructing the third key includes concatenating the first key and the second key.

In a fifth aspect, alone or in combination with one or more of the first through fourth aspects, process 900 includes transmitting to (e.g., using communication manager 160 and/or transmission component 1204), or receiving from (e.g., using communication manager 160 and/or reception component 1202), a UE using integrity protection based on an IPSec SA between the UE and the TNGF.

In a sixth aspect, alone or in combination with one or more of the first through fifth aspects, process 900 includes receiving (e.g., using communication manager 160 and/or reception component 1202), from a target AP, a request for the third key, and transmitting (e.g., using communication manager 160 and/or transmission component 1204), to the target AP, the third key in response to the request.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, an AP, or another wireless communication device) using the reception component 1002 and the transmission component 1004. As further shown, the apparatus 1000 may include the communication manager 140. The communication manager 140 may include one or more of a determination component 1008, a registration component 1010, or a derivation component 1012, among other examples.

In some aspects, the apparatus 1000 may be configured to perform one or more operations described herein in connection with FIGS. 3, 4A, 4B, 4C, 5A, and 5B. Additionally, or alternatively, the apparatus 1000 may be configured to perform one or more processes described herein, such as process 600 of FIG. 6, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

In some aspects, the determination component 1008 may determine to access a trusted network and may determine to access a first AP (e.g., the apparatus 1006). The determination component 1008 may include a controller/processor, a memory, or a combination thereof, of the UE described in connection with FIG. 2. Accordingly, the registration component 1010 may perform a registration procedure with a mobility function of a 5G core network. The registration component 1010 may include one or more antennas, a modem, a demodulator, a MIMO detector, a receive processor, a modulator, a transmit MIMO processor, a transmit processor, a controller/processor, a memory, or a combination thereof, of the UE described in connection with FIG. 2.

Furthermore, the derivation component 1012 may derive a main key, associated with a TNGF, based on the registration procedure. The derivation component 1012 may include a controller/processor, a memory, or a combination thereof, of the UE described in connection with FIG. 2. The determination component 1008 may determine a root key based on the main key, and the derivation component 1012 may derive a first PMK, associated with the trusted network, from the root key. The determination component 1008 may determine to access a second AP for the trusted network. Accordingly, the derivation component 1012 may derive a second PMK, associated with the second AP, from the first PMK.

In some aspects, the transmission component 1004 may transmit to, and/or the reception component 1002 may receive from, the AP using encryption based on the second PMK.

In some aspect, the transmission component 1004 may transmit, to the second AP, an authentication request. The transmission component 1004 may further transmit, to the second AP, a reassociation request based on a response to the authentication request. Therefore, the transmission component 1004 may transmit to, and/or the reception component 1002 may receive from, the second AP using encryption based on the second PMK.

Alternatively, the transmission component 1004 may transmit, to the first AP, an FT request. The transmission component 1004 may further transmit, to the second AP, a reassociation request based on a response to the FT request. Therefore, transmission component 1004 may transmit to, and/or the reception component 1002 may receive from, the second AP using encryption based on the second PMK.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a AP, or a AP may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, another AP, or another wireless communication device) using the reception component 1102 and the transmission component 1104. As further shown, the apparatus 1100 may include the communication manager 150. The communication manager 150 may include one or more of a determination component 1108 or a derivation component 1110, among other examples.

In some aspects, the apparatus 1100 may be configured to perform one or more operations described herein in connection with FIGS. 3, 4A, 4B, 4C, 5A, or 5B. Additionally, or alternatively, the apparatus 1100 may be configured to perform one or more processes described herein, such as process 800 of FIG. 8, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

In some aspects, the reception component 1102 may receive a main key from a TNGF. Accordingly, the determination component 1108 may determine a root key based on the main key. The determination component 1108 may include a controller/processor, a memory, or a combination thereof, of the UE described in connection with FIG. 2.

Furthermore, the derivation component 1110 may derive a first PMK, associated with a trusted network including the AP, from the root key. The derivation component 1110 may include a controller/processor, a memory, or a combination thereof, of the UE described in connection with FIG. 2. The reception component 1102 may receive (e.g., from the apparatus 1106) a request to derive a second PMK for an additional AP included in the trusted network. Accordingly, the derivation component 1110 may derive a second PMK, associated with the additional AP, from the first PMK. The transmission component 1104 may transmit the second PMK to the additional AP. In some aspects, the transmission component 1104 may transmit to, and/or the reception component 1102 may receive from, a UE using encryption based on the second PMK.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a TNGF, or a TNGF may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, an AP, or another wireless communication device) using the reception component 1202 and the transmission component 1204. As further shown, the apparatus 1200 may include the communication manager 160. The communication manager 160 may include one or more of a determination component 1208, a derivation component 1210, or a construction component 1212, among other examples.

In some aspects, the apparatus 1200 may be configured to perform one or more operations described herein in connection with FIGS. 3, 4A, 4B, 4C, 5A, or 5B. Additionally, or alternatively, the apparatus 1200 may be configured to perform one or more processes described herein, such as process 700 of FIG. 7, process 900 of FIG. 9, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

In some aspects, the reception component 1202 may receive a main key associated with a mobility function of a 5G core network and the apparatus 1200. Accordingly, the determination component 1208 may determine a root key based on the main key. The determination component 1208 may include a controller/processor, a memory, or a combination thereof, of the network node described in connection with FIG. 2.

Furthermore, the derivation component 1210 may derive a first PMK, associated with a trusted network including the apparatus 1200, from the root key. The derivation component 1210 may include a controller/processor, a memory, or a combination thereof, of the network node described in connection with FIG. 2. Additionally, the derivation component 1210 may derive a second PMK, associated with an AP (e.g., the apparatus 1206) for the trusted network, from the first PMK. The transmission component 1204 may use the second PMK (e.g., by transmitting the second PMK or transmitting the first PMK to enable derivation of the second PMK) to secure communications between a UE and the AP.

In some aspects, the transmission component 1204 may transmit to, and/or the reception component 1202 may receive from, the UE using integrity protection based on an IPSec SA between the UE and the apparatus 1200.

In some aspects, the reception component 1202 may receive, from a target AP, a request for an additional PMK derived from the first PMK. Accordingly, the transmission component 1204 may transmit, to the target AP, the additional PMK in response to the request.

Alternatively, the derivation component 1210 may derive a first key for an AP based on the main key and may derive a second key based on the main key. Accordingly, the construction component 1212 may construct a third key based on the first key and the second key. The construction component 1212 may include a controller/processor, a memory, or a combination thereof, of the network node described in connection with FIG. 2. Accordingly, the transmission component 1204 may transmit the third key to the AP.

In some aspects, the reception component 1202 may receive, from a target AP, a request for the third key. Accordingly, the transmission component 1204 may transmit, to the target AP, the third key in response to the request.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: determining to access a trusted network; determining to access a first access point (AP); performing a registration procedure with a mobility function of a 5G core network; deriving a main key, associated with a trusted network gateway function (TNGF), based on the registration procedure; determining a root key based on the main key; deriving a first pairwise master key (PMK), associated with the trusted network, from the root key; determining to access a second AP for the trusted network; and deriving a second PMK, associated with the second access point (AP), from the first PMK.

Aspect 2: The method of Aspect 1, wherein the registration procedure comprises an authentication procedure.

Aspect 3: The method of any of Aspects 1-2, wherein the mobility function comprises an access and mobility management function (AMF).

Aspect 4: The method of any of Aspects 1-3, further comprising: determining to access the trusted network; determining to access the first AP; and determining to access the second AP for the trusted network.

Aspect 5: The method of Aspect 4, wherein determining to access the second AP comprises: receiving a broadcast from the second AP; and determining that the second AP is in a same trusted network as the first AP based on a mobility domain identity (MDID) indicated in the broadcast.

Aspect 6: The method of any of Aspects 1-5, wherein the main key is a K_{TNGF} key.

Aspect 7: The method of any of Aspects 1-6, wherein the root key is an XXKey.

Aspect 8: The method of any of Aspects 1-6, wherein the root key is a K_{FT} key.

Aspect 9: The method of any of Aspects 1-8, wherein determining the root key comprises: applying a key derivation function (KDF) to the main key to determine the root key.

Aspect 10: The method of any of Aspects 1-9, wherein determining the root key comprises: deriving the root key from the main key based on a usage type distinguisher.

Aspect 11: The method of any of Aspects 1-8, wherein determining the root key comprises: deriving a first key from the main key based on a first usage type distinguisher; and deriving a second key from the main key based on a second usage type distinguisher, wherein the root key is determined based on the first key and the second key.

Aspect 12: The method of Aspect 11, wherein the root key is a master session key (MSK).

Aspect 13: The method of any of Aspects 11-12, wherein the root key comprises a concatenation of the first key with the second key.

Aspect 14: The method of any of Aspects 1-13, wherein the first PMK is a PMK-R0.

Aspect 15: The method of any of Aspects 1-14, wherein the second PMK is a PMK-R1.

Aspect 16: The method of any of Aspects 1-15, further comprising: transmitting to, or receiving from, the second AP using encryption based on the second PMK.

Aspect 17: The method of any of Aspects 1-16, further comprising: transmitting, to the second AP, an authentication request; transmitting, to the second AP, a reassociation request based on a response to the authentication request; and transmitting to, or receiving from, the second AP using encryption based on the second PMK.

Aspect 18: The method of any of Aspects 1-16, further comprising: transmitting, to the first AP, a fast basic service set (BSS) transition (FT) request; transmitting, to the second AP, a reassociation request based on a response to the FT request; and transmitting to, or receiving from, the second AP using encryption based on the second PMK.

Aspect 19: A method of wireless communication performed by a trusted network gateway function (TNGF), comprising: receiving a main key associated with a mobility function of a 5G core network and the TNGF; determining a root key based on the main key; deriving a first pairwise master key (PMK), associated with a trusted network including the TNGF, from the root key; deriving a second PMK, associated with an access point (AP) for the trusted network, from the first PMK and using the second PMK to secure communications between a user equipment (UE) and the AP.

Aspect 20: The method of Aspect 19, wherein the mobility function comprises an access and mobility management function (AMF).

Aspect 21: The method of any of Aspects 19-20, wherein the main key is a K_{TNGF} key.

Aspect 22: The method of any of Aspects 19-21, wherein the root key is an XXKey.

Aspect 23: The method of any of Aspects 19-21, wherein the root key is a K_{FT} key.

Aspect 24: The method of any of Aspects 19-23, wherein determining the root key comprises: applying a key derivation function (KDF) to the main key to determine the root key.

Aspect 25: The method of any of Aspects 19-24, wherein determining the root key comprises: deriving the root key from the main key based on a usage type distinguisher.

Aspect 26: The method of any of Aspects 19-25, wherein the first PMK is a PMK-R0.

Aspect 27: The method of any of Aspects 19-26, wherein using the second PMK to secure communications comprises: transmitting the second PMK to the AP.

Aspect 28: The method of any of Aspects 19-26, wherein using the second PMK to secure communications comprises: transmitting the first PMK to an access controller (AC), associated with the AP, for deriving the second PMK.

Aspect 29: The method of any of Aspects 19-26, wherein using the second PMK to secure communications comprises: transmitting the first PMK to the AP for deriving the second PMK.

Aspect 30: The method of any of Aspects 19-29, further comprising: transmitting to, or receiving from, the UE using integrity protection based on an Internet protocol security (IPSec) secure association (SA) between the UE and the TNGF.

Aspect 31: The method of any of Aspects 19-30, further comprising: receiving, from a target AP, a request for an additional PMK derived from the first PMK; and transmitting, to the target AP, the additional PMK in response to the request.

Aspect 32: A method of wireless communication performed by an access point (AP), comprising: receiving a main key from a trusted network gateway function (TNGF); determining a root key based on the main key; deriving a first pairwise master key (PMK), associated with a trusted network including the AP, from the root key; receiving a request to derive a second PMK for an additional AP included in the trusted network; deriving a second PMK, associated with the additional AP, from the first PMK; and transmitting the second PMK to the additional AP.

Aspect 33: The method of Aspect 32, wherein the root key is an XXKey.

Aspect 34: The method of Aspect 32, wherein the root key is a K FT key.

Aspect 35: The method of any of Aspects 32-34, wherein the first PMK is a PMK-R0.

Aspect 36: The method of any of Aspects 32-35, wherein the second PMK is a PMK-R1.

Aspect 37: The method of any of Aspects 32-36, further comprising: transmitting to, or receiving from, a user equipment (UE) using encryption based on the second PMK.

Aspect 38: The method of any of Aspects 32-37, wherein the main key is received via an access controller (AC).

Aspect 39: The method of any of Aspects 32-37, wherein the main key is received at an access controller (AC) co-located with the AP.

Aspect 40: The method of any of Aspects 32-39, wherein the request is received from a user equipment (UE), and the method further comprises: transmitting, to the additional AP, the FT request; receiving, from the additional AP, a response to the FT request; and transmitting, to the UE, the response to the FT request.

Aspect 41: The method of any of Aspects 32-39, wherein the request is received from the additional AP.

Aspect 42: A method of wireless communication performed by a trusted network gateway function (TNGF), comprising: receiving a main key associated with a mobility function of a 5G core network and the TNGF; deriving a first key for an access point (AP) based on the main key; deriving a second key based on the main key; constructing a third key based on the first key and the second key; and transmitting the third key to the AP.

Aspect 43: The method of Aspect 42, wherein the first key is a K_{TNAP} key.

Aspect 44: The method of any of Aspects 42-43, wherein the second key is a K_{FT} key.

Aspect 45: The method of any of Aspects 42-44, wherein the third key is a master session key (MSK).

Aspect 46: The method of any of Aspects 42-45, wherein constructing the third key comprises: concatenating the first key and the second key.

Aspect 47: The method of any of Aspects 42-46, further comprising: transmitting to, or receiving from, a user equipment (UE) using integrity protection based on an Internet protocol security (IPSec) secure association (SA) between the UE and the TNGF.

Aspect 48: The method of any of Aspects 42-47, further comprising: receiving, from a target AP, a request for the third key; and transmitting, to the target AP, the third key in response to the request.

Aspect 49: An apparatus for wireless communication at a device, comprising a processor; memory coupled with the processor; and instructions stored in the memory and executable by the processor to cause the apparatus to perform the method of one or more of Aspects 1-48.

Aspect 50: A device for wireless communication, comprising a memory and one or more processors coupled to the memory, the one or more processors configured to perform the method of one or more of Aspects 1-48.

Aspect 51: An apparatus for wireless communication, comprising at least one means for performing the method of one or more of Aspects 1-48.

Aspect 52: A non-transitory computer-readable medium storing code for wireless communication, the code comprising instructions executable by a processor to perform the method of one or more of Aspects 1-48.

Aspect 53: A non-transitory computer-readable medium storing a set of instructions for wireless communication, the set of instructions comprising one or more instructions that, when executed by one or more processors of a device, cause the device to perform the method of one or more of Aspects 1-48.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, configured to:
perform a registration procedure with a mobility function of a 5G core network;
derive a main key, associated with a trusted network gateway function (TNGF), based on the registration procedure;
determine a root key based on the main key;
derive a first pairwise master key (PMK), associated with a trusted network, from the root key;
communicate with a first access point (AP) for the trusted network; and
derive a second PMK, associated with a second AP, from the first PMK.

2. The apparatus of claim 1, wherein the one or more processors are further configured to:
determine to access the trusted network;
determine to access the first AP; and
determine to access the second AP for the trusted network.

3. The apparatus of claim 2, wherein, to determine to access the second AP, the one or more processors are configured to:
receive a broadcast from the second AP; and
determine that the second AP is in a same trusted network as the first AP based on a mobility domain identity (MDID) indicated in the broadcast.

4. The apparatus of claim 1, wherein the main key is a K_{TNGF} key.

5. The apparatus of claim 1, wherein, to determine the root key, the one or more processors are configured to:
apply a key derivation function (KDF) to the main key to determine the root key.

6. The apparatus of claim 1, wherein, to determine the root key, the one or more processors are configured to:
derive the root key from the main key based on a usage type distinguisher.

7. The apparatus of claim 1, wherein the root key is a K_{FT} key.

8. The apparatus of claim 1, wherein the first PMK is a PMK-R0.

9. The apparatus of claim 1, wherein the second PMK is a PMK-R1.

10. The apparatus of claim 1, wherein the one or more processors are further configured to:
transmit to, or receive from, the second AP using encryption based on the second PMK.

11. The apparatus of claim 1, wherein the one or more processors are further configured to:
transmit, to the second AP, an authentication request;
transmit, to the second AP, a reassociation request based on a response to the authentication request; and
transmit to, or receive from, the second AP using encryption based on the second PMK.

12. The apparatus of claim 1, wherein the one or more processors are further configured to:
transmit, to the first AP, a fast basic service set (BSS) transition (FT) request;
transmit, to the second AP, a reassociation request based on a response to the FT request; and
transmit to, or receive from, the second AP using encryption based on the second PMK.

13. An apparatus for wireless communication at a trusted network gateway function (TNGF), comprising:
one or more memories; and one or more processors, coupled to the one or more memories, configured to:
receive a main key associated with a mobility function of a 5G core network and the TNGF;
determine a root key based on the main key;
derive a first pairwise master key (PMK), associated with a trusted network including the TNGF, from the root key;
derive a second PMK, associated with an access point (AP) for the trusted network, from the first PMK; and
use the second PMK to secure communications between a user equipment (UE) and the AP.

14. The apparatus of claim 13, wherein the main key is a K_{TNGF} key.

15. The apparatus of claim 13, wherein, to determine the root key, the one or more processors are configured to:
apply a key derivation function (KDF) to the main key to determine the root key.

16. The apparatus of claim 13, wherein, to determine the root key, the one or more processors are configured to:
derive the root key from the main key based on a usage type distinguisher.

17. The apparatus of claim 13, wherein the root key is a K_{FT} key.

18. The apparatus of claim 13, wherein the first PMK is a PMK-R0.

19. The apparatus of claim 13, wherein, to use the second PMK to secure communications, the one or more processors are configured to:
transmit the second PMK to the AP.

20. The apparatus of claim 13, wherein, to use the second PMK to secure communications, the one or more processors are configured to:
transmit the first PMK to an access controller (AC), associated with the AP, for deriving the second PMK.

21. The apparatus of claim 13, wherein, to use the second PMK to secure communications, the one or more processors are configured to:
transmit the first PMK to the AP for deriving the second PMK.

22. The apparatus of claim 13, wherein the one or more processors are further configured to:
transmit to, or receive from, the UE using integrity protection based on an Internet protocol security (IPSec) secure association (SA) between the UE and the TNGF.

23. The apparatus of claim 13, wherein the one or more processors are further configured to:
receive, from a target AP, a request for an additional PMK derived from the first PMK; and
transmit, to the target AP, the additional PMK in response to the request.

24. An apparatus for wireless communication at an access point (AP), comprising:
one or more memories; and
one or more processors, coupled to the one or more memories, configured to:
receive a main key from a trusted network gateway function (TNGF);
determine a root key based on the main key;
derive a first pairwise master key (PMK), associated with a trusted network including the AP, from the root key;
receive a request to derive a second PMK for an additional AP included in the trusted network;
derive a second PMK, associated with the additional AP, from the first PMK; and
transmit the second PMK to the additional AP.

25. The apparatus of claim 24, wherein the root key is a K_{FT} key.

26. The apparatus of claim 24, wherein the first PMK is a PMK-R0.

27. The apparatus of claim 24, wherein the second PMK is a PMK-R1.

28. The apparatus of claim 24, wherein the one or more processors are further configured to:
transmit to, or receive from, a user equipment (UE) using encryption based on the second PMK.

29. A method performed at a user equipment (UE), comprising:
performing a registration procedure with a mobility function of a 5G core network;
deriving a main key, associated with a trusted network gateway function (TNGF), based on the registration procedure;
determining a root key based on the main key;
deriving a first pairwise master key (PMK), associated with a trusted network, from the root key;
communicating with a first access point (AP) for the trusted network; and
deriving a second PMK, associated with a second AP, from the first PMK.

30. The method of claim 29, wherein determining the root key comprises:
deriving the root key from the main key based on a usage type distinguisher.
